(19) United States
(12) Patent Application Publication
(10) Pub. No.: US 2025/0086557 A1
(43) Pub. Date: Mar. 13, 2025

(54) System and Method for Estimating the Probability of Success in Developing AI-Enhanced Medical Technology Products

(71) Applicant: Edwin Rule, Lowell, MA (US)

(72) Inventor: Edwin Rule, Lowell, MA (US)

(21) Appl. No.: 18/464,785

(22) Filed: Sep. 11, 2023

(51) Int. Cl. G06Q 10/0637

(52) U.S. Cl. CPC G06Q 10/06375

(57) ABSTRACT

A computer system designed for estimating the probability of success in the development of medical technology products, particularly those incorporating artificial intelligence or machine learning elements is disclosed. The computer system includes a computing device housing a central processing unit and having a graphical user interface. The computing device is connected to a memory or a server containing data and files necessary for the operation of a probability of success estimator. The computer system empowers stakeholders in healthcare and biomedical technology fields to make informed decisions and optimize development strategies when utilizing artificial intelligence and machine learning for improved medical solutions.

### BACKGROUND OF THE INVENTION

The present disclosure relates generally to a probability of success estimator. More particularly, the present disclosure relates to a computer system providing a probability of success estimator for the development of medical technology products where artificial intelligence or machine learning are either incorporated into the product or were used in the development of the product.

The field of medical technology (“MedTech”) is witnessing rapid advancements, driven in large part by the integration of artificial intelligence (“AI”) and machine learning (“ML”) technologies. These innovations hold immense promise for enhancing the development of medical devices, software, and solutions, offering the potential to revolutionize healthcare delivery and patient outcomes. However, the complexity and multidimensional nature of MedTech projects, especially ones incorporating AI or ML into the development process or the medical product, pose many challenges.

While there are a potentially endless number of solutions to these challenges, the result of implementing any given solution is uncertain due to the inherently difficult and complex nature of developing innovative medical technology. Therefore, what is needed is a probability of success estimator having all of the further described features and advantages.

### SUMMARY OF THE INVENTION

The subject matter of this application may involve, in some cases, interrelated products, alternative solutions to a particular problem, and/or a plurality of different uses of a single system or article.

In one aspect, a computer system is disclosed. In this aspect the computer system includes a computing device housing a processor and a memory storing instructions for execution by the processor. The system also includes a user interface facilitating access to the system and a user input device in electronic communication with the computing device. A monitor in electronic communication with the computing device displays the user interface, and an electronic communication line connects the computing device to a server containing a database. The computer system is operable to estimate a likelihood of success for the development of a medical technology product.

In another aspect, a method for estimating a likelihood of success for the development of a medical technology product is disclosed. In this aspect, the method involves calculating the likelihood of success for the development of the medical technology product, wherein either the development of the product or the final product itself utilizes artificial intelligence. The method also involves displaying the likelihood of success on a user interface, presenting reasons behind the likelihood of success determination in a detailed report, and displaying factors contributing to the likelihood of success determination on a graphical chart.

### BRIEF DESCRIPTION OF DRAWINGS

FIG. 1 provides a diagrammatic representation of one embodiment of the computer system.

FIG. 2 provides a representation of one embodiment of the information used by the computer system to estimate a probability of success.

FIG. 3 provides a flowchart representation of one embodiment of the method performed by the computer system in response to external inputs.

FIG. 4 provides a perspective view of one embodiment of a graphical user interface according to the present disclosure.

FIG. 5 provides a perspective view of another embodiment of a graphical user interface according to the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and/or the sequence of steps for constructing and operating the invention in connection with the illustrated embodiments.

Generally, the present disclosure concerns a computer system for estimating the probability of success of a project. Specifically, the computer system is operable to estimate a probability of success for the development of medical technology (“MedTech”) products where artificial intelligence (“AI”) or machine learning (“ML”) are either incorporated into the product or were used during the development process for the product.

In one embodiment, the system may include a non-transitory computer readable medium or memory, which contains instructions allowing and instructing at least one central processing unit (“CPU” or “processor”) to carry out the steps required during estimating a likelihood of success, as described herein. This non-transitory computer readable medium or memory may be housed within a computing device, or may be accessible through an electronic communication system, such as a network. When used herein the term “computing device” means any electronic device having a processor, memory, and a graphical user interface (“GUI”) display, including, but not limited to, a cellular phone, a tablet, a laptop, or a desktop. Also, when used herein the term “network” refers to any system of interconnected electronic devices, such as, a cellular communication network or the Internet. Connections in the network may be wired or wireless.

In one embodiment, the computer system may be operable to assess the likelihood of success in MedTech product development projects involving AI or ML. In another embodiment, the computer system or may be configured to operate a probability of success estimator or calculator that may independently assess the likelihood of success for AI/ML MedTech projects. The computer system and/or the probability of success estimator, may offer a comprehensive evaluation of project-specific details, team expertise, and development practices. It may assign a numerical rating to gauge the probability of project success, aiding decision-making processes such as project continuation or termination. The terms “computer system” and “probability of success estimator” may be used interchangeably throughout the present disclosure.

Beyond numerical ratings, in one embodiment the probability of success estimator may provide a dual assessment. For example, it may evaluate both the likelihood that a MedTech product in development will ultimately function as intended and the likelihood of obtaining regulatory approval, potentially from agencies like the United State Food and Drug Administration (“FDA”). Input data for the computer system may be collected through responses to sixteen (16) questions across four (4) categories and may incorporate two (2) scaling factors, including, regulatory pathway considerations and the team's prior MedTech development experience, irrespective of AI/ML involvement.

Notably, the probability of success calculator may employ a streamlined scoring system with three options: a score of seven (7) for excellent practices, a score of four (4) for acceptable practices, and a score of one (1) for less desirable practices. This quantitative approach may allow for an enhanced understanding of project success probability while offering quantitative insights into areas where potential challenges may arise. These insights may enable targeted actions to address specific areas of vulnerability, facilitating more informed decision-making and risk management in MedTech development.

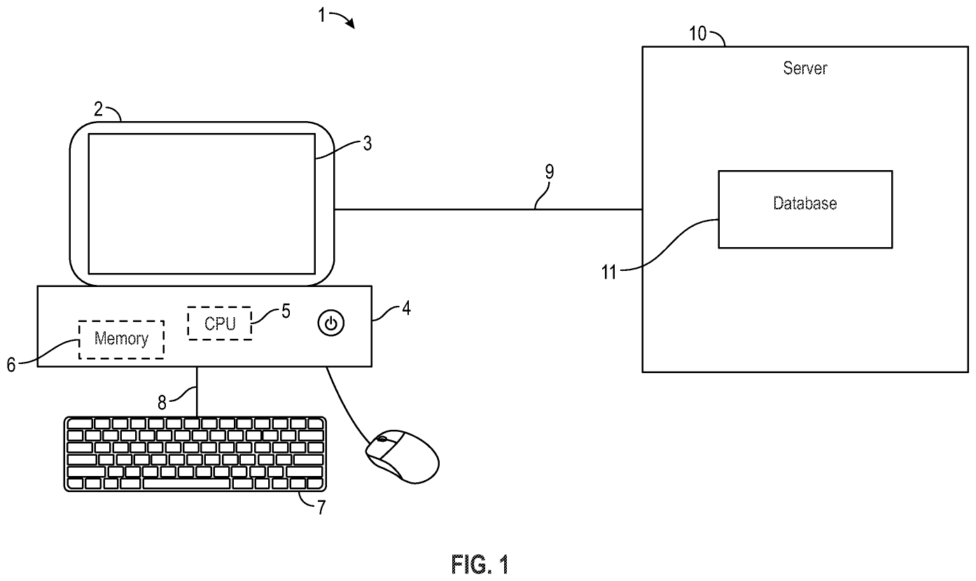

Turning now to FIG. 1, a diagrammatic representation of one embodiment of the computer system 1 is shown. In this embodiment, the computer system comprises several key components, including, but not limited to a monitor 2 and a graphical user interface 3. The monitor 2 facilitates user access to the system 1 by providing a graphical user interface 3 through which users interact with the system. As used herein, the term “monitor” encompasses any electronic display or visual output device capable of presenting graphical or textual information to a user. Such monitors may include, but are not limited to, desktop computer monitors, laptop screens, tablet displays, mobile phone screens, and any other portable or fixed electronic screens or displays designed for human interaction and information presentation.

The computer system 1 also includes a computing device 4, which serves as the core processing unit. The computing device 4 comprises essential components, including, but not limited to, a central processing unit or processor 5 and a memory 6. The central processing unit 5 is responsible for executing various instructions and performing computational tasks. The memory 6 stores instructions and data that are essential for the operation of the computer system and/or the probability of success estimator. These stored instructions are executed by the processor 5 during operation of the system 1.

Similar to the term “monitor,” as used herein, the term “computing device” encompasses any electronic device or apparatus with the capability to process data, execute instructions, and perform computational tasks. Such computing devices may include, but are not limited to, desktop computers, laptops, tablet computers, mobile phones, servers, embedded systems, wearable devices, and any other electronic systems or hardware configured for information processing, storage, and communication.

To facilitate user interaction with the computer system 1, user input devices 7 are provided. In the embodiment shown in FIG. 1, these devices 7 include a mouse and a keyboard, but the term “input device” is meant to encompass any hardware or components designed to facilitate user interaction and input with a computing device, including, but not limited to, touchscreens. The input devices 7 are connected to the computing device 4 through electronic communication lines 8. These communication lines can be either short-range wireless connections, such as a Bluetooth® connection, or hard-wired connections.

As previously described, the computer system 1 includes a computing device 4 and a monitor 2. In this context, the computing device 4 is configured to cause the monitor 2 to display a website or application that embodies the probability of success estimator on the user interface 3. This user interface 3 provides users with a platform to interact with and utilize the probability of success estimator.

To enable communication and data transfer between the computing device 4 and the monitor 2, an electronic communication line 9 is established. This line 9 may encompass both wired and wireless connections, including connections to computerized device networks, such as the Internet, cellular networks, and the like. The electronic communication line 9 connects the computing device 4 to a server 10 specifically designed to support the probability of success estimator functionality. This server 10 contains a database 11 that stores the necessary files and information required for the operation of the probability of success estimator website or application. Such files and information may include historical data, statistical models, user preferences, and any other relevant information. This information may also be stored, entirely or in part, on the memory 6 of the computing device 4.

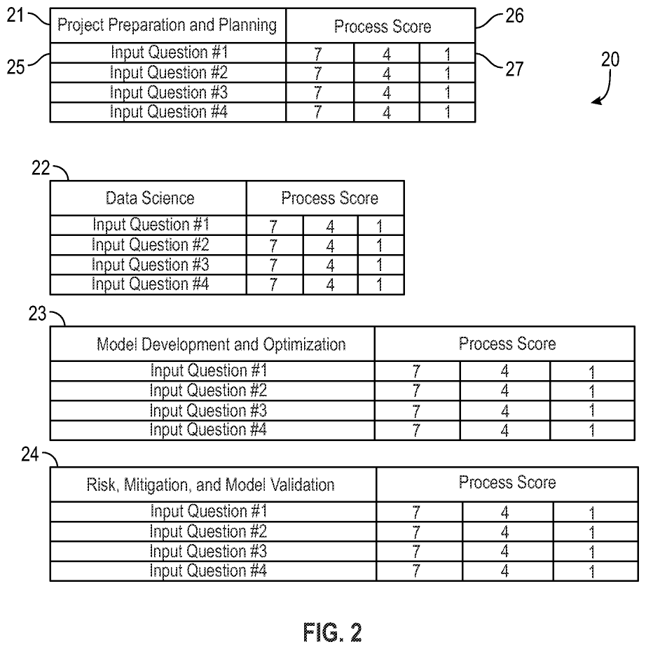

In FIG. 2, a graphical representation of one embodiment of the information used by the computer system 1 to estimate a probability of success for the development of a MedTech product is presented. In this embodiment, the estimation process is structured around four general categories, each of which plays a crucial role in assessing or estimating a probability of success.

The “Project Preparation and Planning” category 21 encompasses the initial stages of preparing and planning the development of the MedTech product. This category may be a critical foundation for the success of the project.

The “Data Science” category 22 focuses on the utilization of data-driven techniques and methodologies in the development process. It may involve gathering, analyzing, and deriving insights from relevant data sources.

The “Model Development and Optimization” category 23 pertains to the creation and refinement of models, algorithms, or systems that underpin the MedTech product. This category may involve continuous improvement and optimization efforts.

The “Risk, Mitigation and Model Validation” category 24 is concerned with identifying potential risks, mitigating them, and validating the effectiveness of the models and methodologies used in the project. It may address the overall safety and reliability of the MedTech product.

Within each of the four categories, 21, 22, 23, and 24, the computer system 1 is designed to receive specific inputs related to four questions 25. These questions 25 enable the system to calculate a process score 26 for each question, thereby providing a quantitative measure of the performance or compliance in that specific aspect of the category. Ultimately, the system aggregates these process scores 26 to calculate an overall score for each category or area of interest (“AOI”).

In one embodiment, the computer system 1 may display the input questions 25 on a questionnaire. The four input questions 25 may be different for each category 21, 22, 23, and 24. For example, each of the four input questions for each of the four categories may be selected from the group consisting of the following questions:
What procedures exist that describe processes for data, modeling, risk assessment and validation?
Is there documentation of use of data analysis (EDA, normalization, scaling, etc.) on input/output data?
Has the Project Team completed a written definition and application of modeling parameters (QofI, Model Influence, Decision Consequence)?
Is the project bound by a definition of a minimum Model Accuracy (error threshold)?
What requirements dictate for data integrity, privacy, security and diversity?
In what way are clinicians involved in data review/feature selection?
What norms are applied to evaluate the completeness and accuracy of data used in model selection, development or training?
How robust is the documentation of methods of pre-processing data (rules for removing outliers, filling missing data)?
What are the processes for identification, selection and evaluation of a model/features/optimization method(s)?
How extensive is the training and experience of the Subject Matter Expert (SME) who will describe the model identification, selection and validation process?
What method(s) used for model optimization and what degree of transparency exists in the model?
What evidence can be provided to demonstrate that the model accuracy exceeds threshold?
How extensive is the definition of risks (safety and security risks) and how robust are mitigations to those risks?
Are safety and security risks integrated into the same risk assessment process or in parallel and connected processes?
Has model risk been quantified? Does it consider the modeling parameters (above)?
How rigorous is the process for model validation? Is there evidence to demonstrate Generalizability?
Do you use Project Management software to determine project schedules and resource requirements and to track the progress of your development project?
What is the technical background of project sponsor(s) (member(s) of the management team who approve the project charter, project plan, project budget, resource allocations, schedules, etc.)?
Which International Standards (eg. IEC 60601-1-10, ASME V&V 40) or Guidance Documents (Predetermined Change Control Plan, Proposed Regulatory Framework for AI/ML, etc.) are being applied to the development of your AI/ML project?
Do you document Regulatory Deliverables (those documents—test reports, evaluations/assessments, etc. that will be assembled to form the regulatory submission) and does the Project Manager and each stakeholder (or their management) formally accept responsibility for the deliverables that are assigned to them?
Do you have a policy to pull software code from ONLY trusted sources/libraries?
Do you have a policy for data Extraction, Transformation and Loading (ETL)?
Are project documents subject to QMS audits? How often are audits conducted?
What is the policy for making changes to project goals and plans? Are those policies documented? When are management approvals required in order for a proposed change to be approved?
Are Performance Tests done in-house or are they contracted to a third-party?
Are third-party service providers who are involved in the development and/or verification of the medical device required to possess certifications (such as ISO 17025)?
Is the software used for model development Part 11 compliant?
Is the software that is used for model development validated in accordance with FDA's, General Principles of Software Validation Guidance?
What design considerations are incorporated to ensure cyber-security (e.g., Data Encryption, Certificate Management, Secure Boot, etc.)?
Are changes to the data-trained algorithm or adaptive algorithm reviewed by qualified personnel (software engineers, clinicians, quality assurance, etc.) prior to implementation? How is this done?
What evaluations are performed to ensure that outputs are indicative of causation and not merely correlation?

Referring back to FIG. 2, in this particular embodiment, the computer system 1 employs a structured scoring system to assess and calculate the probability of success for the development of a MedTech product. This scoring system operates on a “7, 4, 1” scale 27, where each score corresponds to a level of competence and the need for improvement.

For example, a score of seven (7) signifies advanced competence with minimal need for improvement. It may indicate a high level of proficiency or excellence in a particular aspect of the development process. A score of four (4) represents average competence with some amount of targeted improvement required. It may suggest a moderate level of proficiency with room for enhancement in specific areas. A score of one (1) denotes minimal competence with a significant amount of work needed. It may imply a lower level of proficiency and a substantial need for improvement in the assessed aspect.

For each of the input questions 25 related to the four categories or AOIs, 21, 22, 23, or 24, the computer system 1 calculates a process score 26 for an input response based on the aforementioned “7, 4, 1” scale 27. These process scores quantify the performance or competence level in each assessed aspect. To determine the overall score for each category or AOI, the process scores 26 for each of the individual question responses may be added together. Notably, each AOI has a maximum attainable overall score of twenty-eight (28) (i.e., Four (4) Input Question Responses Times(×) Maximum Scaled Score of Seven (7)=Twenty-Eight (28)). This may ensure that the overall score for each AOI remains within a consistent range.

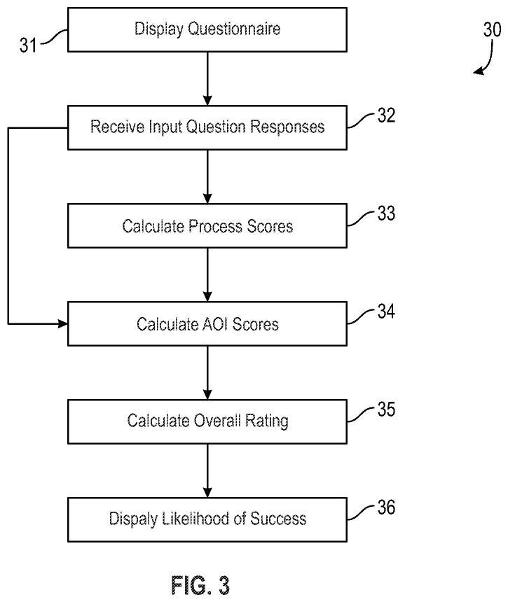

FIG. 3 presents a flowchart representation of one embodiment of a method 30 performed by the computer system 1 in response to external inputs. This method is intended to calculate the probability of success for a MedTech project systematically. For example, in response to an external input, such as the activation of a hyperlink, the launch of a computer application, or the selection of a prompt on a user interface, the computer system 1 initiates the probability of success calculation method 30.

First, the system 1 is operable to display a questionnaire 31 containing a series of questions, as previously described. These questions are designed to assess specific aspects related to the development of the MedTech project. The questions are associated with the four general categories or AOIs. Users or operators interact with the questionnaire by providing input responses 32 to each of the questions. These responses are critical in the subsequent calculation process.

The input responses 32 are utilized to calculate process scores 33 for each individual question. These process scores quantitatively evaluate the competence or performance level of the project in each assessed aspect. For example, in one embodiment, the computer system may be operable to designate individual areas within a MedTech project as “High Likelihood of Success,” “Borderline Likelihood of Success,” or “Low Likelihood of Success” based on the calculated process scores 33 for the individual question responses 32.

The quantitative evaluation of the process scores 33 by the computer system 1 also illustrates a technical problem solved by the present disclosure. For example, converting human text from the input responses 32 into a quantitative process score 33, also known as sentiment analysis or text analysis, is a complex process with several technical challenges, all of which stem from the inherent complexity of having a binary machine interpret human language. Conventional, rule-based approaches struggle with nuances, context, and domain-specific language, making them less effective in capturing the true sentiment within textual data. However, at least one embodiment of the present disclosure solves this problem by integrating a machine learning algorithm, particularly a Large Language Model (“LLM”) that allows the computer system 1 to accurately interpret complex language constructs, negations, slang, and the like.

A LLM is a class of machine learning system that is designed to process human-like text based on extensive training on large amounts of text data. In one embodiment, the text data may be stored in a database on a server, and a processor may ultimately execute the steps required for training the computer system. A LLM generally works through a two-step process: pre-training and fine-tuning.

In the pre-training phase, the LLM may be exposed to a vast corpus of text from one or more databases, where it may learn statistical patterns, syntax, grammar, and semantic relationships present in the data. The LLM may capture word associations, context and even complex linguistic constructs during this initial phase.

In the second phase, fine-tuning may tailor the LLM for specific tasks or domains, such as sentiment analysis. During this phase, the LLM may be trained on labeled datasets where the correct process score(s) (e.g., 7, 4, or 1) is/are provided for text examples. Fine-tuning may adjust the LLM's internal parameters to optimize its performance for the specific task of translating input responses on a questionnaire into quantitative process scores. This process allows the LLM to capture the rich and varied ways people express their opinions and emotions in text, resulting in more accurate and nuanced sentiment analysis outcomes (e.g., process score calculations).

In an embodiment where the received input question responses 32 are human text, having a computer processor and/or server utilize a LLM solves the problem of having a binary machine interpret human text. Now, while the use of a LLM may solve a technical computer problem, it may also create another technical computer problem. For example, sentiment analysis models may inherit biases present in training data. These biases may result in skewed sentiment predictions especially for underrepresented groups or topics.

In order to solve this potential problem created by the use of a LLM, the computer system may utilize a self-diagnostic algorithm to periodically assess the weightings assigned to various project-specific factors. This self-diagnostic algorithm may operate as a safeguard to ensure that biases in the sentiment analysis model are detected and mitigated. The system may do this by periodically evaluating the model's performance and identifying any patterns of bias or inaccuracies in sentiment predictions. In response to the self-diagnosis, the computer system may be operable to recalibrate its own sentiment analysis model. This recalibration process may involve adjusting the model's parameters and training data to minimize biases and improve the accuracy of sentiment analysis, particularly for underrepresented groups or topics. By implementing this self-diagnostic and recalibration approach, the computer system can provide more fair and unbiased sentiment analysis results, addressing the potential bias-related challenges posed by LLMs.

Alternatively, in one embodiment, to avoid the aforementioned problems, the input responses 32 may already be numerical process scores, obviating the need for a separate calculation step 33. Regardless of the embodiment, the system 1 is operable to calculate overall scores for each AOI 34 after receiving or determining the individual process scores. The overall AOI scores calculated 34 by the system 1 represent an aggregate assessment of the entire category based on the performance in individual questions. As previously described, the maximum achievable score for each AOI may be twenty-eight (28).

After the calculation of AOI scores 34, the system 1 calculates the sum of each overall AOI score in order to calculate an overall rating 35. The calculated sum of the overall AOI scores is then divided by the maximum possible sum for all four overall AOI scores to arrive at a value equal to or less than one (1) but greater than zero (0). In this embodiment, the maximum possible sum for all four overall AOI scores is one hundred and twelve (112) (i.e., 28×4=112).

After calculating the sum of each overall AOI score and dividing this value by the maximum possible sum for all four overall AOI scores, the system 1 incorporates scaling factors, which allow for the quotient to be adjusted based on certain criteria. These scaling factors include, but are not limited to, a prior experience with MedTech product development and the chosen regulatory pathway for approval. The quotient, which in almost every case is a fraction, is then scaled using the specified scaling factors. Once scaled, the product is then multiplied by one hundred (100) to yield an overall rating or a likelihood of success percentage for the MedTech product or project. Once the overall rating is calculated 35, the system 1 is then operable to display the likelihood of success 36 on a user interface.

For example, in an embodiment where the maximum possible sum for the overall AOI scores is one hundred and twelve (112), and the sum of the overall scores for each AOI is ninety six (96), the quotient to the nearest thousandth would be 0.857. However, if the individual or team inquiring about a likelihood of success has significant prior experience in MedTech product development and the chosen regulatory pathway is favorable, the quotient may be scaled up before multiplication by one hundred (100). In this case the overall rating may be greater than ninety percent (90%).

Similarly, if the maximum possible sum is one hundred and twelve (112) and the sum of the overall scores for each AOI is one hundred and eight (108), the quotient would be 0.964. However, if the team or company lacks prior experience in MedTech product development, and the regulatory pathway does not favor approval, the quotient may be scaled down before multiplication by one hundred (100). In this case, the overall rating may be less than seventy percent (70%).

In situations where information for one or more scaling factors is not known (i.e., not input), the system 1 may still perform the calculation of the overall rating 35 based on the input factors, if any. For example, in one embodiment, the system may calculate an overall rating 35 based on either one (1) or zero (0) scaling factors by not scaling the quotient by the missing factor.

In one embodiment, before or after accounting for any applicable scaling factors, the computer system 1 may be operable to designate individual AOIs within a MedTech project as “High Likelihood of Success,” “Borderline Likelihood of Success,” or “Low Likelihood of Success” based on the calculated overall AOI scores 34. In such an embodiment, an overall AOI score equal to or greater than twenty five (25) may correspond to an AOI being designated as a High Likelihood of Success. An overall AOI score between twenty four (24) and twenty two (22), inclusive, may correspond to a Borderline Likelihood of Success AOI, and a score of equal to or less than twenty one (21) may correspond to a Low Likelihood of Success.

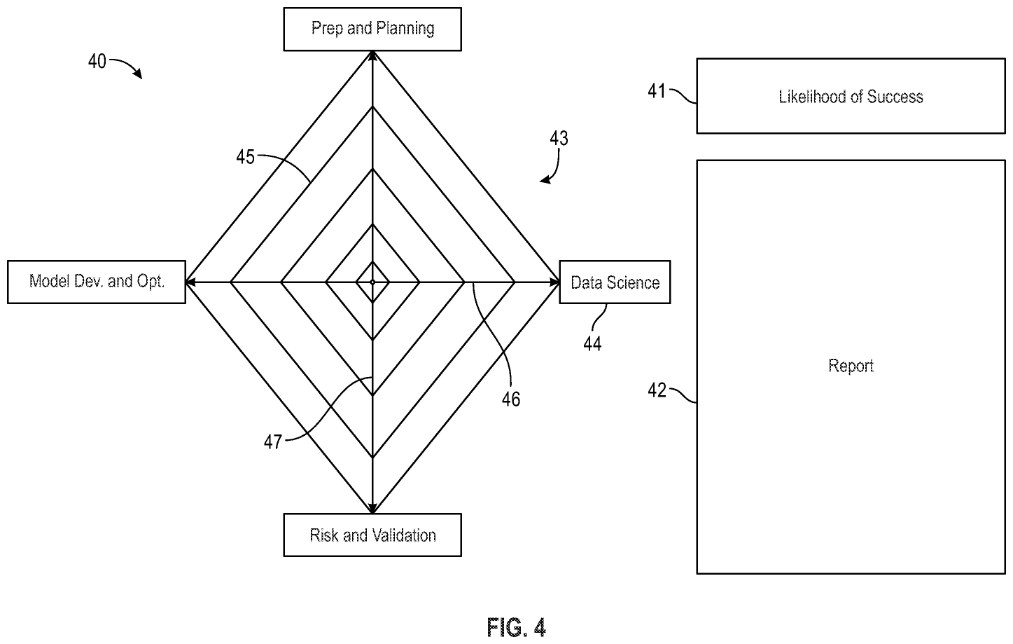

Turning now to FIG. 4, which provides a perspective view of a user interface 40 that displays the likelihood of success 41 for a MedTech project. The user interface also includes a detailed report 42 that explains the reasons behind the determination of the likelihood of success. Additionally, a graphical representation in the form of a chart 43 is presented alongside the likelihood of success 41. The chart 43 serves as a graphical representation of the reasons contributing to the likelihood of success determination. It takes the form of a symmetrical square centered on an origin point. Within this chart 43, each of the four corners represents one of the four AOIs 44, and the sum total of the process scores for each of the four AOIs 44 may be displayed on the coordinates 45 of the chart.

The arrangement of the four AOIs 44 on the chart 43 is deliberate and designed to define two independent project success axes: a “Device Function Axis” 46 and a “Regulatory Approval Axis” 47. For example, in this embodiment, the AOIs related to “Model Development and Optimization” and “Data Science” are positioned on directly opposite corners of the chart 43. This arrangement defines the “Device Function Axis” 46. Similarly, the AOIs concerning “Preparation and Planning” and “Risk and Validation” are arranged on directly opposite corners of the chart 43. This arrangement defines the “Regulatory Approval Axis” 47.

The Device Function Axis 46 aims to assess the likelihood that a MedTech product will function as intended or that a MedTech project will achieve its intended results. In other words, this axis focuses on the technical and functional aspects of the project. On the other hand, the Regulatory Approval Axis 47 is meant to estimate the likelihood that a regulatory authority, such as the FDA, will approve the MedTech product or project. In other words, this axis 47 addresses the compliance and regulatory aspects of the project.

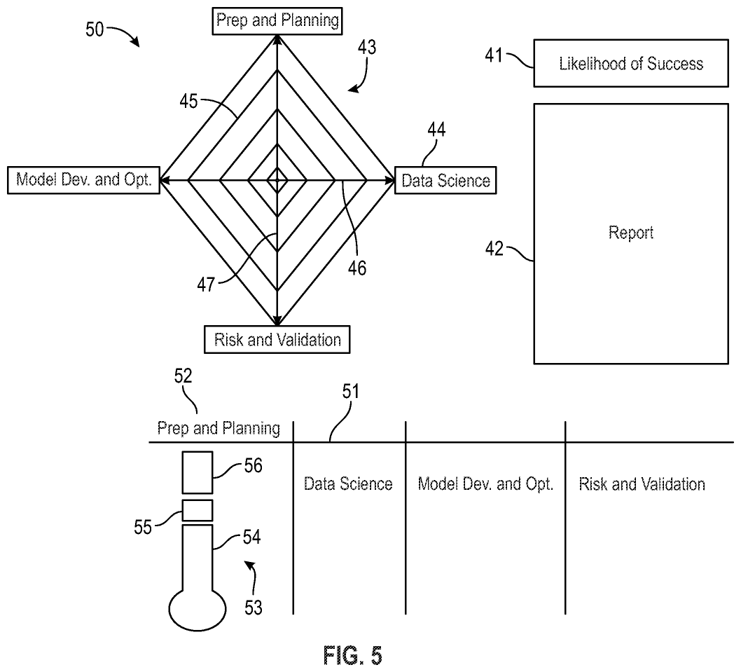

FIG. 5 provides a perspective view of a hybrid user interface 50 simultaneously displaying both the user interface 40 for the overall likelihood of success 41 and a user interface 51 for the overall process scoring details for each of the four AOIs 44. Specifically, when the computing device receives an input selecting one of the four AOIs 44, the system is operable display overall process scoring details for the selected AOI 52 on the same interface 50 as the overall likelihood of success 41 for the MedTech project or product.

In this embodiment, the overall process scoring details for the selected AOI 52 are displayed in the form of a thermometer chart 53. The thermometer chart 53 comprises three sections, a bottom section 54, a middle section 55, and a top section 56. The bottom section 54 corresponds to an overall score of from 0 to 21, inclusive, for the selected AOI 52. Similarly, the middle section 55 corresponds to an overall score of from 22 to 24, inclusive, and the top section 56 corresponds to an overall score of equal to or greater than 25 for the selected AOI 52. When the overall score for the selected AOI 52 (i.e., the sum total of the process scores for each individual input question response with the category) is within any one of the foregoing ranges, the computer system is operable to emphasize the corresponding section 54, 55, or 56 by using a specific color, highlighting, size scaling, and the like. This visual representation may provide immediate feedback and help users quickly identify the performance level in the chosen AOI 52.

While all of the embodiments described herein represent a technical improvement, the embodiment shown in FIG. 5 in particular illustrates a technical problem solved in the field of computer systems, and specifically, computer systems that are operable to calculate probabilities of success. It is common in the field of probability of success estimators for the computer system to only display an overall likelihood of success and not the factors that are used in the likelihood of success determination. For example, in the present disclosure the overall process scores for each of the four AOIs 44 are factors used to determine the likelihood of success 41.

In known systems, it would be common for the selection of one of the four AOIs 44 to cause the computing device to navigate to a separate user interface displaying specific details about the selected AOI. This separate user interface may be displayed from a different website address on a server or in a separate window on a computer or mobile application. The reason for the factors that are used to determine the probability of success being displayed on a separate user interface may be a limited availability of display space on computer monitors or mobile device screens, which is a technical problem specific to computerized devices that can disrupt user workflow and potentially lead to a loss of context.

However, the present disclosure solves this problem by creating a hybrid user interface 50 that simultaneously displays both the likelihood of success 41 for a MedTech project or product and the overall process scoring details for at least one selected AOI 52 on the same user interface 50, particularly in the form of a thermometer chart 53. This hybrid interface 50 not only solves a technical problem in the field of computers, but it also helps users identify and target specific areas for improvement without needing to navigate away from a primary user interface 40 and potentially losing track of progress. In other words, this feature ensures that critical information is readily accessible and promotes efficient decision-making in MedTech project assessment.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A computer system comprising:
a computing device housing a processor and a memory, the memory storing instructions for execution by the processor;
a user interface facilitating access to the computer system;
a user input device in electronic communication with the computing device;
a monitor in electronic communication with the computing device, the monitor configured to display the user interface; and
an electronic communication line connecting the computing device to a server containing a database;
wherein the computer system is operable to estimate a likelihood of success for a development of a medical technology product.

2. The computer system of claim 1 wherein the database stores a plurality of files and information necessary for an operation of a probability of success estimator.

3. The computer system of claim 1 wherein the development of the medical technology product utilizes artificial intelligence.

4. The computer system of claim 1 wherein the medical technology product utilizes artificial intelligence.

5. The computer system of claim 1 wherein the user interface displays the likelihood of success as a percentage.

6. The computer system of claim 1 wherein the user interface displays a report explaining a plurality of reasons for the likelihood of success.

7. The computer system of claim 1 wherein the user interface displays a graphical chart comprising four corners, wherein each of the four corners corresponds to one of four areas of interest.

8. The computer system of claim 7 wherein a first one of the four areas of interest is a project preparation and planning.

9. The computer system of claim 7 wherein a second one of the four areas of interest is a data science.

10. The computer system of claim 7 wherein a third one of the four areas of interest is a model development and optimization.

11. The computer system of claim 7 wherein a fourth one of the four areas of interest is a risk, mitigation, and model validation.

12. The computer system of claim 1 wherein the user interface displays an overall process score for an area of interest.

13. The computer system of claim 1 wherein the computer system is operable to estimate the likelihood of success based on a scaling factor.

14. The computer system of claim 13 wherein the scaling factor comprises at least one of a prior experience or a regulatory pathway.

15. The computer system of claim 1 wherein the computer system is operable to calculate an overall rating.

16. The computer system of claim 1 wherein the user interface displays a thermometer chart for an area of interest.

17. A method for estimating a likelihood of success for a development of a medical technology product, comprising:
calculating the likelihood of success for the development of the medical technology product, wherein at least one of the development or the medical technology product utilize artificial intelligence;
displaying the likelihood of success on a user interface;
presenting reasons behind the likelihood of success determination in a detailed report; and
displaying factors contributing to the likelihood of success determination on a graphical chart.

18. The method of claim 17 further comprising calculating an overall rating before calculating the likelihood of success.

19. The method of claim 18 wherein the overall rating is calculated by dividing a sum total of an overall process score for a plurality of areas of interest by a maximum possible sum for the sum total to yield a quotient.

20. The method of claim 19 wherein the overall rating is further calculated by scaling the quotient by a scaling factor and multiplying the scaled quotient by 100 to yield the likelihood of success.
